(19) United States
(12) Patent Application Publication
(10) Pub. No.: US 2015/0172590 A1
(43) Pub. Date: Jun. 18, 2015

(54) RECEIVING DEVICE, AND CONTROL METHOD, DEVICE AND SYSTEM FOR VIDEO REFRESH FREQUENCY

(71) Applicants: ANALOGIX (China) SEMICONDUCTOR, INC, Beijing (CN); ANALOGIX INTERNATIONAL LLC, Wilmington, DE (US)

(72) Inventors: Xin Wang, Beijing (CN); Haifeng Liu, Beijing (CN); Qingqing Xie, Beijing (CN)

(73) Assignees: ANALOGIX (CHINA) SEMICONDUCTOR, INC., Haidian District, Beijing (CN); ANALOGIX INTERNATIONAL LLC, Wilmington, DE (US)

(21) Appl. No.: 14/371,327

(22) PCT Filed: Dec. 26, 2012
(86) PCT No.: PCT/CN2012/087533

§ 371 Date: Jul. 9, 2014

(30) Foreign Application Priority Data
Jan. 10, 2012 (CN) 201210006245.6

(51) Int. Cl. H04N 5/63; G09G 5/393

(52) U.S. Cl. CPC H04N 5/63; G09G 5/393; G09G 2330/021; G09G 2340/0435

(57) ABSTRACT

A receiving device and a control method, device and system video refresh frequency, the method comprising: receiving a video stream and a first refresh frequency of the video stream (S102), the video stream comprising one or more video frames; saving the video stream to a Frame Buffer (BF) area (S104); invoking each video frame in the FB area, and controlling the output time of each video frame according to a second refresh frequency, the first refresh frequency being greater than the second refresh frequency (S106). The present method improves the energy performance on a panel side, thus reducing the power consumption of the whole display system.

### FIELD

The disclosure relates to the field of Liquid Crystal Displays (LCDs), more particularly relating to a receiving device, and a control method, device and system for video refresh frequency.

### BACKGROUND

A Timing Controller (TCON), which is a sub-system chip in an Liquid Crystal Display (LCD), receives upstream video stream data (from a multimedia processor or a Graphics Processing Unit (GPU)), and recombines a video stream to drive a source electrode to drive a component Integrated Circuit (IC) so as to display the video stream on a screen.

An Embedded DisplayPort (eDP) interface, which is a standard display interface of the Video Electronics Standards Association (VESA), is defined to be applied to an embedded application. For example, eDP may be used as a video input interface of TCON. The Panel Self-Refresh (PSR) function is an optional characteristic of eDP, and the PSR characteristic reduces system-level energy consumption when a displayed image is provided with a plurality of static display frames. A sink device saves a static image locally in a Remote Frame Buffer (RFB) module in a receiver and displays the image, and may simultaneously close a main DP link and may also simultaneously close a source (e.g. Central Display Unit (CPU) or GPU) that generates a video.

An eDP standard technology is applied in the prior art, which may save a great deal of energy at a video source end (or video source terminal) side during PSR application by closing an eDP video source end (or closing a GPU). Although energy has been saved by the video source end side through the prior art, the energy consumption of a panel display side is still very high during application in an energy-sensitive environment, e.g. a laptop computer, a tablet computer and a mobile phone, thus the whole energy performance of the system is still poor.

At present, there is no effective solution to the problem that the whole energy performance of a system is poor even after application of a PSR function due to high energy consumption of a panel display side.

### SUMMARY

The disclosure is put forward to solve the problem that the whole energy performance of a system is poor during application of a Panel Self-Refresh (PSR) function due to high energy consumption of a panel display side in the prior art and the problem that there is no effective solution at present. Therefore, the main purpose of the disclosure is to provide a receiving device, and a control method, device and system for video refresh frequency to solve the problem of continuing to reduce energy consumption of a display device during the PSR application.

To realize the purpose above, a control method of a video refresh frequency is provided according to an aspect of the disclosure. The method includes: receive a video stream and a first refresh frequency of the video stream, wherein the video stream includes one or more video frames; save the video stream to an framebuffer (FB) area; and invoke each video frame in the FB area, and control the output time of each video frame according to a second refresh frequency, wherein the first refresh frequency is greater than the second refresh frequency.

Preferably, after saving the video stream to the FB area, the method further includes: generate a handshaking signal and send the handshaking signal to a video source end (or video source terminal); the video source end closes the output of the video stream according to the handshaking signal, wherein the video source end is configured to generate the video stream, and send the video stream according to the first refresh frequency.

Preferably, the video source end closes the output of the video stream by closing a power source or closing the video source end.

Preferably, after the video source end closes the output of the video stream according to the handshaking signal, the method further includes: in a preset condition, start the video source end, and after updating the first refresh frequency, the video source end sends a new video stream.

Preferably, the step of starting the video source end in the preset condition includes: control to start the video source end within a preset period of time, or start the video source end according to a trigger signal.

Preferably, through a TCON, the second refresh frequency is controlled to remain unchanged or the second refresh frequency is controlled to switch among one or more frequencies.

Preferably, the step of controlling the output time of each video frame according to the second refresh frequency includes: a clock generator in the TCON generates a control signal that controls the output time of the video frame to control regular synchronous transmission of the video frame.

To realize the purpose above, a receiving device is provided according to an aspect of the disclosure. The receiving device includes: a receiving port, configured to receive a video stream and a first refresh frequency of the video stream, wherein the video stream includes one or more video frames; an framebuffer (FB) chip, including an FB area configured to save the video stream; and a Timing Controller (TCON), configured to invoke each video frame in the FB area, and control the output time of each video frame according to a second refresh frequency, wherein the first refresh frequency is greater than the second refresh frequency.

Preferably, a clock generator of the TCON generates a control signal controlling the sending time of the video frame to control regular synchronous transmission of the video frame.

To realize the purpose above, a control system of video refresh frequency is provided according to an aspect of the disclosure. The system includes: the receiving device and the system further includes: a video source end, configured to generate the video stream and send the video stream to the receiving device according to the first refresh frequency.

Preferably, the video source end includes: a memory chip, configured to generate the video stream; a video processing and control chip, configured to invoke each video frame in the video stream in the memory chip and control the output time of each video frame according to the first refresh frequency; and a sending port, configured to send the video stream.

Preferably, the memory chip is an FB in a memory.

Preferably, after the FB chip saves the video stream, the TCON generates a handshaking signal, and sends the handshaking signal to the video source end; the video source end closes the output of the video stream according to the handshaking signal.

Preferably, the video source end closes the output of the video stream by closing a power source or closing the video source end.

To realize the purpose above, a control device of a video refresh frequency is provided according to another aspect of the disclosure. The device includes: a receiving module, configured to receive a video stream and a first refresh frequency of the video stream, wherein the video stream includes one or more video frames; an image data storage module, coupled with the receiving module and configured to save the video stream to an framebuffer (FB) area; and a control module coupled with the image data storage module, configured to invoke each video frame in the FB area and control the output time of each video frame according to a second refresh frequency, wherein the first refresh frequency is greater than the second refresh frequency.

Preferably, the device further includes: a generating module, configured to generate a handshaking signal; and a sending module coupled with the generating module, configured to send the handshaking signal to the video stream end, the video source end closes the output of the video stream according to the handshaking signal; wherein the video stream end is configured to generate the video stream and send the video stream according to the first refresh frequency.

Preferably, the control module includes: a clock generator module coupled with the image data storage module, configured to generate a control signal that controls the output time of the video frame to control regular synchronous transmission of the video frame.

Through the disclosure, a video stream and a first refresh frequency of the video stream are received, wherein the video stream includes one or more video frames; the video stream is saved to an framebuffer (FB) area; each video frame in the FB area is invoked, and the output time of each video frame is controlled according to a second refresh frequency; wherein the first refresh frequency being greater than the second refresh frequency, thus solving the problem that the whole energy performance of a system is poor during application of a PSR function due to high energy consumption of a panel display side in the prior art to further improve the energy effect of the whole display system by improving the energy performance of the panel side.

### BRIEF DESCRIPTION OF THE DRAWINGS

The accompanying drawings described here are used for providing further understanding to the disclosure and constitute a part of the application. The exemplary embodiments of the disclosure and the illustrations thereof are used for explaining the disclosure, instead of constituting an improper limitation to the disclosure. In the accompanying drawings:

FIG. 1 is a structural diagram of a control system for video refresh frequency according to an embodiment of the disclosure;

FIG. 2 is a flowchart of a control method for video refresh frequency according to an embodiment of the disclosure;

FIG. 3 is a detailed flowchart of a control method for video refresh frequency according to an embodiment of the disclosure;

FIG. 4 is an architecture diagram of a seamless technology according to an embodiment of the disclosure; and

FIG. 5 is a structural diagram of a control device for video refresh frequency according to an embodiment of the disclosure.

### DETAILED DESCRIPTION OF THE EMBODIMENTS

It should be noted that, if there is no conflict, the embodiments in the application and the characteristics in the embodiments can be combined with one another. The disclosure will be described in details below with reference to the accompanying drawings and in combination with the embodiments.

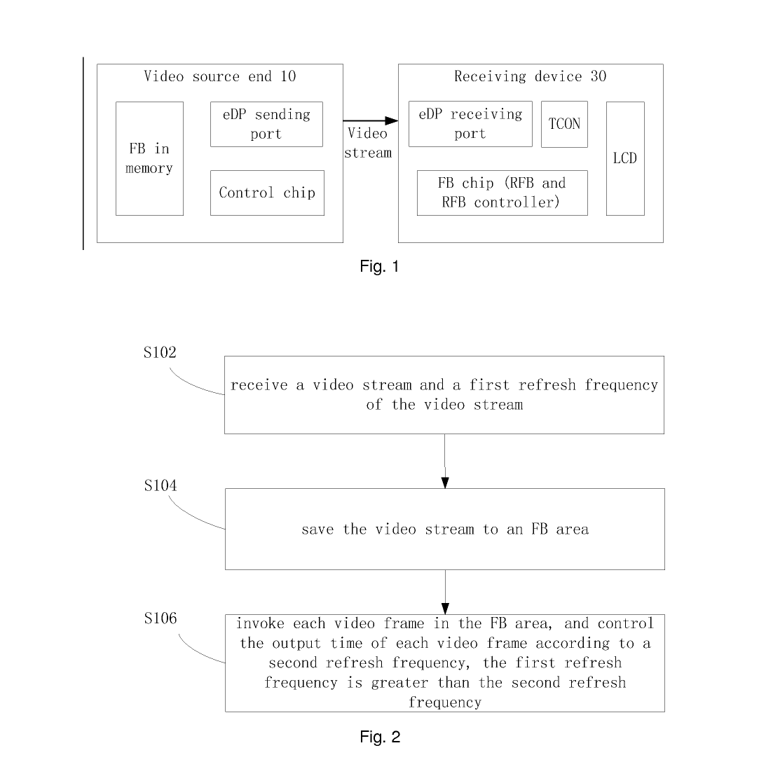

FIG. 1 is a structural diagram of a control system for video refresh frequency according to an embodiment of the disclosure.

As shown in FIG. 1, the system includes: a video source end 10 and a receiving device 30,

wherein the video source end (or video source terminal) 10 is configured to generate a video stream and send the video stream to the receiving device 30 according to a first refresh frequency.

The receiving device 30 may include: a receiving port, configured to receive the video stream and the first refresh frequency of the video stream, wherein the video stream includes one or more video frames; an framebuffer (FB) chip, including an FB area configured to save the video stream; and a Timing Controller (TCON), configured to invoke each video frame in the FB area, and control the output time of each video frame according to a second refresh frequency, wherein the first refresh frequency is greater than the second refresh frequency.

The embodiment of the application provides a PSR-based Dynamic Refresh Rate Changing (PSR-DRRC) technology by adjusting the refresh frequency of a display screen in the receiving device 30, specifically by reducing the refresh frequency. Since the TCON controls the output time of each video frame in the FB area at a refresh frequency lower than the original refresh frequency, more system energy can be saved without changing the system level to save energy of a panel side of the system in a PSR mode. In addition, the energy may be saved while avoiding any visual defect. At the same time, an output interface of from the TCON to an LCD source electrode driver will not perform any resynchronization at a driving side under a normal mode.

The embodiment improves a PSR mode defined in eDP standards, thus having the advantage of saving energy at a panel side to further improve the energy performance at the panel side. The improvement is of great importance in an energy-sensitive environment, e.g. a laptop computer, a tablet computer and a mobile phone etc.

The video source end (or video source terminal) 10 in the embodiment of the application may further include: a memory chip (an FB in a memory), configured to generate the video stream; an FB control chip, configured to invoke each video frame in the video stream in the memory chip and control the output time of each video frame according to the second refresh frequency; and a sending port, configured to send the video stream. Preferably, after the FB chip saves the video stream, the TCON may generate a handshaking signal and send the handshaking signal to the video source end 10; the video source end 10 closes the output of the video stream according to the handshaking signal. The output of the video stream may be closed by means of closing a power source or closing the video source end etc., i.e. the video source end does not need to send a new video frame at the moment.

While reducing energy consumption at the panel side, the embodiment further closes other source electrode functions to reduce energy consumption. Therefore, the main advantage of the PSR mode in the embodiment of the application is to reduce energy consumption at the video source end 10 and the panel side simultaneously so that a user may reduce more system-level energy consumption in the case of acceptably stable video display.

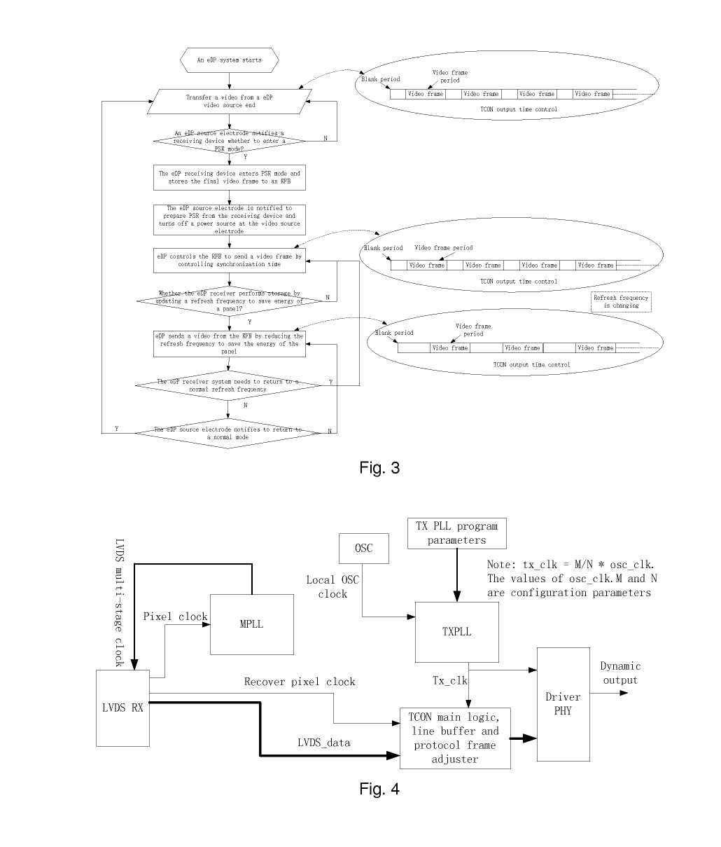

FIG. 2 is a flowchart of a control method for video refresh frequency according to an embodiment of the disclosure and FIG. 3 is a detailed flowchart of a control method for video refresh frequency according to an embodiment of the disclosure.

The method as shown in FIG. 2 includes the following steps:

Step 102: receive a video stream and a first refresh frequency of the video stream through the receiving port in FIG. 1, and wherein the video stream includes one or more video frames.

Step 104: save the video stream to an FB area through the FB chip in FIG. 1.

Step 106: execute and invoke each video frame in the FB area through the TCON in FIG. 1, and control the output time of each video frame according to a second refresh frequency, wherein the first refresh frequency is greater than the second refresh frequency.

When a refresh frequency is relatively low, panel energy consumption will be less than that in a normal condition previously. Therefore, by adjusting the refresh frequency of a display screen in the receiving device 30, specifically by reducing the refresh frequency, the embodiment of the application provides a PSR-DRRC technology. Since the TCON controls the output time of each video frame in the FB area at a frequency lower than the original refresh frequency, more system energy can be saved without changing the system level to save energy of a panel side of the system in a PSR mode.

In the embodiment of the application, after saving the video stream to the FB area, the method may further include: generate a handshaking signal and send the handshaking signal to a video source end 10; the video source end 10 closes the output of the video stream according to the handshaking signal, wherein the video source end 10 is configured to generate the video stream, and send the video stream according to the first refresh frequency. The step further closes a power source of the video source end 10 to further reduce the energy consumption. The output of the video stream may be closed by means of closing a power source or closing the video source end etc. in the application, i.e. the video source end does not need to send a new video frame at the moment.

In addition, after the video source end 10 closes the output of the video stream according to the handshaking signal, the method further includes: in a preset condition, start the video source end, and after updating the first refresh frequency, the video source end sends a new video stream. At the moment, the video source end 10 may send the video stream after reducing the first refresh frequency according to actual conditions so that the energy consumption of the video source end 10 is reduced compared with the previous embodiment. The preset condition in the application may be controlling to start the video source end within a preset period of time, or starting the video source end according to a trigger signal.

Specifically, it may be learned according to the detained flowchart as shown in FIG. 3 that a detailed working process of the embodiment of the application may be as follows:

first, start an eDP system; after it is determined that the system controls to enter a PSR mode, under a PSR mode of an eDP TCON, a video source end 10 of eDP will notify a receiving device 30 of eDP to receive video frames and send all video frames to the receiving device 30 according to an initial refresh frequency; the receiving device 30 saves the received video frames in a module RFB of an FB chip;

subsequently, the video source end 10 may close the video stream according to a handshaking signal returned by the receiving device 30 or may close a power source of the whole eDP video source end 10, which means that the receiving device 30 will not obtained an upstream video stream any more. The receiving device 30 starts to extract the video stream from the RFB and sends the video stream to be displayed. At the moment, the video stream saved in the RFB may be a local video frame;

subsequently, the TCON in the receiving device 30 will control the sending time of the local video frame by using a refresh frequency lower than the initial refresh frequency; specifically, the eDP of the TCON may generate a control signal that controls the sending time of the video frame to control regular synchronous transmission of the video frame, i.e. the video stream transmitted regularly may be controlled by a clock generator in the TCON, thus generating a pixel clock frequency, a horizontal frequency and a half-frame frequency (also called refresh frequency). In the step of the application, the refresh frequency generated by the TCON is controlled to be lower than the received initial refresh frequency, thus reducing the refresh frequency under local dynamic control to save more panel energy.

From the foregoing, it can be learned that the video source end 10 (e.g. GPU) controls a refresh frequency of video display in a normal display mode. After determining to enter a PSR mode, the video source end 10 will notify the receiving device 30 to save each received video frame to the RFB in turn; subsequently, a controller will control the TCON to generate sending time that controls a video frame so as to display the saved video frame. The sending time that controls the video frame is a refresh frequency lower than an initial video. In addition, after the last video frame is saved to the RFB, the power source of the eDP video source end 10 can be completely closed. The PSR-DRRC technology provided by the above embodiment of the application may become a powerful supplement to eDP standards to reduce more panel energy consumption.

Preferably, in the above embodiment of the application, the second refresh frequency may be further remained unchanged through control of a TCON, or the second refresh frequency is controlled to switch among one or more frequencies. Specifically, during implementation of the embodiment, the second refresh generated by the TCON may apply the same video time control as the eDP video source end 10 (the same as the first refresh frequency), and the second refresh frequency may switch between a low frequency and a high frequency, thus realizing a dynamic refresh frequency in the PSR mode. In an implementation process of the embodiment, the TCON determines the current second refresh frequency according different received trigger signals, e.g. between two actions of viewing a stationary image with a receiving terminal and clicking with a mouse, since the energy consumption required by viewing the stationary image is obviously lower, a video refresh frequency of viewing the stationary image may be lower than a video refresh frequency of using the mouse so that the system may dynamically select different refresh frequencies in different terminal usage conditions, thus further reducing energy consumption. Of course, the second refresh frequency may be also maintained without switching.

The following list shows parameters of a video size (1280×800) having different refresh frequencies as an example.

| | 60 Hz | 50 Hz | 40 Hz | Units |
|---|---|---|---|---|
| Pixel Clock | 71.00 | 59.167 | 47.33 | Mhz |
| Horizontal Active | 1280 | 1280 | 1280 | Pixels |
| Horizontal Blank | 160 | 160 | 160 | Pixels |
| Horizontal Front Porch | 48 | 48 | 48 | Pixels |
| Horizontal Sync | 32 | 32 | 32 | Pixels |
| Horizontal Back Porch | 80 | 80 | 80 | Pixels |
| Vertical Active | 800 | 800 | 800 | Lines |
| Vertical Blank | 23 | 23 | 23 | Lines |
| Vertical Front Porch | 3 | 3 | 3 | Lines |
| Vertical Sync | 6 | 6 | 6 | Lines |
| Vertical Back Porch | 14 | 14 | 14 | Lines |

FIG. 4 is an architecture diagram of a seamless technology according to an embodiment of the disclosure. As shown in FIG. 4, the embodiment of the application may be further combined with a seamless technology so that an output signal from a TCON to a driver chip cannot be affected by changes of a refresh frequency. All changes are seamless without any obvious visual defect, i.e. when the refresh frequency changes, the seamless technology can ensure that a visual defect will not be generated during a seamless conversion process between refresh frequencies, and energy power consumption of a panel is saved simultaneously.

In addition, after entering a PSR-DRRC mode, the system may resume a normal refresh frequency. When a video refresh frequency changes during a vertical blank period, an interface signal of the seamless technology can ensure that conversions between a normal PSR mode and a low energy PSR mode are seamless.

When a video source end 10 is activated and determines to send a video frame through eDP, the system will notify an eDP TCON and reestablish an eDP connection, and then transmits a new video frame from the video source end 10. An eDP receiving device 30 stops reading the video frame from an RFB and enters a normal display mode from a PSR mode. Because of the seamless technology, the conversion in the normal display mode is also verified to be seamless.

Specifically, the seamless technology involved in the embodiment of the application may stabilize interface signals of a TCON and a driver and ensure conversion at any modes to be seamless, e.g. a Built-In Self-test (BIST) mode and a normal display mode and the seamless technology is also applicable to a PSR mode. Conversation at any mode should be performed during a vertical blank period, which will protect display from a visual defect.

When a LCD system needs to be controlled by a voltage, the voltage is controlled by charging of a capacitor and a pixel capacitor of each panel should be charged once in one frame, therefore the energy of the panel is sensitive to a video refresh frequency. For example, when a refresh frequency is 60 Hz, it means that a capacitor of each LCD pixel should be charged once at 16.67 ms; when a refresh frequency is 50 Hz, it means that a LCD pixel capacitor should be charged once at 20 ms. As the charging period is prolonged, charging power consumption will be reduced. In the case that a TCON is activated by using the seamless technology, an output signal of the TCON is controlled by a frequency static Phase-Locked Loop (PLL) and maintained stable during mode conversion. The PSR-DRRC technology uses such a characteristic to use a dynamic refresh frequency to read a video frame from an RFB, so as to obtain a display image and constantly send interface signals to a source electrode driver.

For example, when the refresh frequency changes from 60 Hz to 50 Hz, the panel power consumption will be greatly reduced. Theoretically, ⅙ of power consumption may be saved compared with the initial refresh frequency.

In another aspect, the LCD display performance will be affected by a charging period because of a leakage current of each capacitor. If the charging period is too long (which means that the refresh frequency is relatively low), LCD display will become relatively dark than before. However, if the refresh frequency does not turn too low, the display performance will not be affected obviously. It is concluded by the experiment that obvious display conversion cannot be detected by human eyes when the refresh frequency changes from 60 Hz to 40 Hz.

The Low Voltage Differential Signaling (LVDS) interface in the embodiment as shown in FIG. 4 is only an illustrative video interface and any video interface (e.g. eDP) may be used as a video input interface without affecting the seamless technology. At the moment, an output signal is controlled by a Transmitter PLL (TXPLL) provided with a local reference clock (Open Sound Control (OSC) clock source electrode). Since there are sufficient video line buffers to store data of one or two video lines in a TCON, the output of the TCON may transmit an accurate video content at a stable bit rate (also known as clock rate) at any mode even if a video refresh rate of an input video (LVDS or eDP or others) or locally control changes constantly.

It should be noted that the steps illustrated in the flowcharts in the accompanying drawings may be executed in a computer system, e.g. a group of computer-executable instructions. In addition, although the logical sequences have been illustrated in the flowcharts, the steps as illustrated or described may be executed according to sequences different from those described herein in some cases.

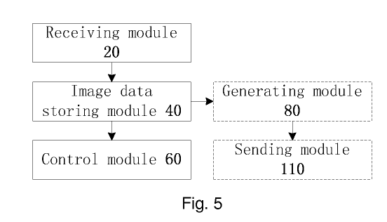

FIG. 5 is a structural diagram of a control device for video refresh frequency according to an embodiment of the disclosure. As shown in FIG. 5, the control device for video refresh frequency may include: a receiving module 20, configured to receive a video stream and a first refresh frequency of the video stream, wherein the video stream includes one or more video frames; an image data storage module 40, coupled with the receiving module 20 and configured to save the video stream to an FB area; and a control module 60 coupled with the image data storage module 40, configured to invoke each video frame in the FB area and control the output time of each video frame according to a second refresh frequency, and finally perform display according to a display time sequence control requirement in a display device, wherein the first refresh frequency is greater than the second refresh frequency.

The embodiment of the application provides a PSR-DRRC technology by adjusting a refresh frequency of a display screen in a receiving device 30, specifically by reducing the refresh frequency. Since a TCON controls the output time of each video frame in an FB area at a refresh frequency lower than the original refresh frequency, more system energy can be saved without changing the system level, i.e. the energy of a panel side in a PSR mode of the system may be saved. In addition, the energy may be saved without causing any visual defect. At the same time, an output interface from the TCON to a driver will also not perform any resynchronization action at a driving side under a normal mode.

The control module 60 in the embodiment of the application is further configured to control the video stream of an image to be displayed according to a display time sequence control requirement on a display device (LCD) at the first refresh frequency.

Preferably, the device may further include: a generating module 80, configured to generate a handshaking signal; and a sending module 110, coupled with the generating module 80 and configured to send the handshaking signal to the video stream end; the video source end closes the output of the video stream according to the handshaking signal, wherein the video stream end is configured to generate the video stream and send the video stream according to the first refresh frequency.

Preferably, the control module 60 may include: a clock generator module coupled with the image data storage module 40 and configured to generate a control signal that controls the output time of the video frame to control regular synchronous transmission of the video frame.

The receiving module 20, the image data storage module 40, the control module 60, the generating module 80, the sending module 110 and the clock generator module in the embodiment of the application may be preferably implemented by software. However, implementation using hardware or a combination of software and hardware is also possible and conceivable, i.e. the functional modules of the application may be implemented by a hardware structure including a processor or a logic-arithmetic unit etc. in a computer or a server.

The embodiment of the application may further provide a computer program for running the control method or device for video refresh frequency and a storage device storing the computer program.

It can be seen from the description above that the disclosure realizes the following technical effect: the application improves a PSR mode defined in an existing eDP standard. The technology has the advantage of saving energy at a display side (GPU side). On this basis, the disclosure improves the energy performance at a panel side. The improvement is of great importance in an energy-sensitive environment, e.g. a laptop computer, a tablet computer and a mobile phone. Compared with a common PSR function, the power consumption may be reduced by 10% to 20% by using a PSR-DRRC function.

Obviously, those skilled in the art should understand that the modules or steps of the disclosure may be implemented by general computing devices and centralized in a single computing device or distributed in a network consisting of multiple computing devices. Optionally, the modules or steps may be implemented by program codes executable by the computing devices, so that they may be stored in a storage device and executed by the computing devices, or respectively made into integrated circuit modules or multiple modules or steps among them may be made into a single integrated circuit module. By doing so, the disclosure is not limited to any specific combination of hardware and software.

The above are only preferred embodiments of the disclosure and should not be used for limiting the disclosure. For those skilled in the art, the disclosure may have various modifications and changes. Any modifications, equivalent replacements, improvements and the like within the spirit and principle of the disclosure shall fall within the scope of protection of the disclosure.

What is claimed is:

1. A control method of a video refresh frequency, comprising:
receiving a video stream and a first refresh frequency of the video stream,
wherein the video stream comprises one or more video frames;
saving the video stream to a Frame Buffer (FB) area; and
invoking each video frame in the FB area, and controlling an output time of each video frame according to a second refresh frequency;
wherein the first refresh frequency is greater than the second refresh frequency.

2. The method according to claim 1, wherein after saving the video stream to the FB area, the method further comprises:
generating a handshaking signal and sending the handshaking signal to a video source end; and
the video source end closing an output of the video stream according to the handshaking signal,
wherein the video source end is configured to generate the video stream, and send the video stream according to the first refresh frequency.

3. The method according to claim 2, wherein the video source end closes the output of the video stream by closing a power source or closing the video source end.

4. The method according to claim 2, wherein after the video source end closes the output of the video stream according to the handshaking signal, the method further comprises:
starting the video source end in a preset condition, and after updating the first refresh frequency, sending a new video stream by the video source end.

5. The method according to claim 4, wherein the step of starting the video source end in the preset condition comprises: controlling to start the video source end within a preset period of time, or starting the video source end according to a trigger signal.

6. The method according to claim 1, wherein through a Timing Controller (TCON), the second refresh frequency is controlled to remain unchanged or the second refresh frequency is controlled to switch among one or more frequencies.

7. The method according to claim 2, wherein the step of controlling the output time of each video frame according to the second refresh frequency comprises: a clock generator in the TCON generating a control signal that controls the output time of the video frame to control regular synchronous transmission of the video frame.

8. A receiving device, comprising:
a receiving port, configured to receive a video stream and a first refresh frequency of the video stream, wherein the video stream comprises one or more video frames;
an FB chip, comprising an FB area, configured to save the video stream; and
a Timing Controller (TCON), configured to invoke each video frame in the FB area, and control an output time of each video frame according to a second refresh frequency,
wherein the first refresh frequency is greater than the second refresh frequency.

9. The receiving device according to claim 8, wherein a clock generator of the TCON generates a control signal that controls the output time of the video frame to control regular synchronous transmission of the video frame.

10. A control system of a video refresh frequency, comprising: the receiving device according to claim 8, and the system further comprising:
a video source end, configured to generate the video stream and send the video stream to the receiving device according to the first refresh frequency.

11. The system according to claim 10, wherein the video source end comprises:
a memory chip, configured to generate the video stream;
a control chip, configured to invoke each video frame in the video stream in the memory chip and control the output time of each video frame according to the first refresh frequency; and
a sending port, configured to send the video stream.

12. The system according to claim 11, wherein the memory chip is an FB in a memory.

13. The system according to claim 11, wherein after the FB chip saves the video stream, the TCON generates a handshaking signal, and sends the handshaking signal to the video source end; the video source end closes an output of the video stream according to the handshaking signal.

14. The system according to claim 13, wherein the video source end closes the output of the video stream by closing a power source or closing the video source end.

15. A control device for a video refresh frequency, comprising:
a receiving module, configured to receive a video stream and a first refresh frequency of the video stream, wherein the video stream comprises one or more video frames;
an image data storage module, coupled with the receiving module and configured to save the video stream to an FB area; and
a control module coupled with the image data storage module and configured to invoke each video frame in the FB area and control an output time of each video frame according to a second refresh frequency,
wherein the first refresh frequency is greater than the second refresh frequency.

16. The device according to claim 15, wherein the device further comprises:
a generating module, configured to generate a handshaking signal; and
a sending module coupled with the generating module and configured to send the handshaking signal to the video stream end; the video source end is configured to close an output of the video stream according to the handshaking signal, wherein the video stream end is configured to generate the video stream and send the video stream according to the first refresh frequency.

17. The device according to claim 15, wherein the control module comprises: a clock generator module coupled with the image data storage module and configured to generate a control signal that controls the output time of the video frame to control regular synchronous transmission of the video frame.

18. The method according to claim 2, wherein through a Timing Controller (TCON), the second refresh frequency is controlled to remain unchanged or the second refresh frequency is controlled to switch among one or more frequencies.

19. The method according to claim 3, wherein through a Timing Controller (TCON), the second refresh frequency is controlled to remain unchanged or the second refresh frequency is controlled to switch among one or more frequencies.

20. The method according to claim 4, wherein through a Timing Controller (TCON), the second refresh frequency is controlled to remain unchanged or the second refresh frequency is controlled to switch among one or more frequencies.

21. The method according to claim 5, wherein through a Timing Controller (TCON), the second refresh frequency is controlled to remain unchanged or the second refresh frequency is controlled to switch among one or more frequencies.

22. A control system of a video refresh frequency, comprising a receiving device, wherein said receiving device comprises:
a receiving port, configured to receive a video stream and a first refresh frequency of the video stream, wherein the video stream comprises one or more video frames;
an FB chip, comprising an FB area, configured to save the video stream; and
a Timing Controller (TCON), configured to invoke each video frame in the FB area, and control an output time of each video frame according to a second refresh frequency;
wherein the first refresh frequency is greater than the second refresh frequency, and wherein a clock generator of the TCON generates a control signal that controls the output time of the video frame to control regular synchronous transmission of the video frame; and
the system further comprising: a video source end, configured to generate the video stream and send the video stream to the receiving device according to the first refresh frequency.
